(19) United States
(12) Patent Application Publication
(10) Pub. No.: US 2005/0118945 A1
(43) Pub. Date: Jun. 2, 2005

(54) Device for transmitting electrical energy in a cabled telecommunication system

(75) Inventors: Fabrice Frebel, Wandre (BE); Michel Paque, Esneux (BE); Paul Bleus, Jupille (BE)

Correspondence Address: LADAS & PARRY, 26 WEST 61ST STREET, NEW YORK, NY, 10023, US

(73) Assignee: CE + T INTERNATIONAL

(21) Appl. No.: 10/991,892

(22) Filed: Nov. 18, 2004

(30) Foreign Application Priority Data
Nov. 28, 2003 (EP) 03078766.7

(51) Int. Cl. H04B 1/00

(52) U.S. Cl. 455/3.02

(57) ABSTRACT

Device for transmitting energy in a system for cabled telecommunication. The system comprises first and second pairs of telecommunication wires (TP). The device comprises a central module or base station arranged to be connected to an electrical energy source and for the first and second pairs of wires to be connected thereto. A satellite comprises a first satellite converter. The first satellite converter comprises a first input arranged for the first pair of wires to be connected thereto and a second input arranged for the second pair of wires to be connected thereto.

### BACKGROUND OF THE INVENTION

The present invention concerns a device for transmitting energy in a cabled transmission system, the system comprising first and second pairs of telecommunication wires (TP). Such a device typically comprises a central module or base station arranged to be connected to an electrical energy source, and for connecting thereto the first and second pairs of wires. The satellite or auxiliary station comprises a first satellite converter. This first satellite converter comprises a first input arranged for the first pair of wires to be connected thereto.

Given the changes in telecommunications network and the need to add or provide in the satellites devices such as demultiplexers for optical-fibres, it is necessary to equip these satellites with energy supplies for this purpose.

Rather than providing, for one or each or some of the satellites, a distinct energy supply from a more or less closed electrical system, and therefore to have to install therein on each occasion in particular a energy meter, a rectifier, batteries to be maintained therein, ventilation, etc, it is preferred to be able to receive the necessary energy from the energy source available at the central module, favourably reducing in the satellites the equipment to be used therein, and therefore also the installation and maintenance of the said equipment as well as the type of receptacle for this at the location of the satellite.

It is already known how to make coexist, in one and the same cable between central module and satellite, pairs of twisted wires used for different purposes, principally
for analogue signals in the bandwidth from 300 to 3400 Hz with very low voltages (VLV: i.e. <60 V dc),
for transporting data in the band from 25 kHz to a few MHz, using very low voltages (VLV: i.e. <60 V dc),
for transporting energy in a secure manner with voltages above 60 V dc, in particular up to 400 V dc (typically 320 V dc but with very low fault currents (<25 mA in all cases).

A remote supply system is illustrated on page 289 of the document “No Power, No Service, No Revenue”, published on the occasion of the Intelec conference of 14-18 Oct. 2001 (Conference Publication No. 484). According to this principle, the central module comprises a converter connected to the energy source on the one hand and to power or current limiters. Each of these limiters is connected to a respective pair of wires. On the satellite side, each pair of wires is connected to a satellite converter. In other words, this document presents a remote supply system using the principle of independence of the pairs of wires.

Compared with a conventional system for the local supply of energy, such a system makes it possible to reduce the maintenance cost of the supply device and offers centralised control of the energy supply. One drawback, however, of this known system is that it still comprises a large number of items of equipment, which impairs the efficiency of the system. In particular, it is planned that, for each pair of wires, a satellite converter be provided.

### BRIEF SUMMARY OF THE INVENTION

One objective of the present invention is to provide a remote energy supply system having a higher efficiency, whilst further reducing the maintenance costs and where applicable installation costs.

To achieve this aim, the device according to the invention is characterised in that the first satellite converter comprises a second input arranged so as to connect the second pair of wires thereto. By making provision for several pairs of wires to be connected to the same satellite converter, it is possible therefore to obtain a system of dependence of pairs comprising a series of groups of pairs of wires, each group of pairs of wires being connected to the same satellite converter. The number of satellite converters is considerably reduced, which facilitates maintenance. In a particular case comprising 48 pairs of wires, it is possible for example to provide 16 satellite converters which are each connected to three pairs of wires. Current technology makes it possible to provide up to around ten pairs of wires on the same converter.

In a first preferential embodiment of the energy transmission device in a cabled telecommunications system, the system also comprising third and fourth pairs of telecommunication wires, the satellite comprises a second satellite converter arranged for the third and fourth pairs of wires to be connected thereto. The central module is arranged for the third and fourth pairs of wires to be connected thereto. This same central module is also arranged to produce a first signal and to transmit this first signal to the first and second pairs of wires, and to produce a second signal different from the first signal and to transmit this second signal to the third and fourth pairs of wires. According to this device, a distinctive signal is thus generated for each group of pairs, which helps the final user to determine easily to which group each pair of wires belongs. In other words, means of identifying the pairs of wires are provided. Advantageously, this is achieved by transmitting low-frequency signals, typically between 3 and 300 Hz, a band not used in telecommunication.

In order not to have to worry about problems of polarities, the satellite converter preferably comprises diode bridges. Each diode bridge comprises a non-biased input connected to one of the entries of the satellite converter and a biased output. The biased outputs are connected to each other and are arranged so as to supply energy to the input stage of the satellite converter.

The safety of the device according to the invention is increased when impedance measuring means are provided arranged to measure the input impedance of the satellite converter and control means connected to the measuring means and arranged to cause a cutting off of the supply to the pairs of wires concerned if the input impedance measured (Zem) has a value different from a range of predetermined values. The range of predetermined values is typically around the input impedance of the satellite converter.

The device preferably comprises control means arranged to control the current limitation level for each pair of wires. This makes it possible, when the energy transmission is started up, to transmit energy whilst limiting the level to a very low value, for example around 5 milliamperes. Such a current is without danger to any humans in contact with the pairs of wires. Next, during “normal” functioning mode, the current limitation level can be increased to a higher value, for example around 60 milliamperes.

In order to enable the central module to detect an abnormality in the transmission to the satellite converters, the satellite converters are arranged to generate an identification signal and to transmit it to the central module and the central module is arranged so as to receive the identification signal. The identification signal is preferably the measurement of the input current of the satellite converter and the central module comprises means arranged to cause a cutting off of the supply to the pair of wires concerned when the difference between the input current of the satellite converter and the corresponding output current of the central module reaches a predetermined threshold.

The central module is preferably arranged to generate a cutting off of current in one of the pairs of wires whilst maintaining the supply in the other pairs of wires. This makes it possible to maintain a supply in the system when a breakdown occurs in only a few pairs of wires. In one particular case where a breakdown occurs on a pair belonging to a group of six pairs, the remaining five pairs can, during the cutting off of energy supply to the “broken down” pair, transport the electrical energy which would normally have had to pass through this pair.

According to a particular embodiment, the central module comprises, for each pair of wires, a respective central converter. It is however conceivable to provide a single central converter combined with current limiters.

A system to which the invention relates can comprise a base station or central module, an electrical energy source available at the central module and having a nominal voltage, at least one auxiliary or satellite station to be supplied with electrical energy, and pairs of telecommunication wires which connect the central module and the satellite. There may be several central modules of different sizes, connected together or not. One or more satellites can be connected to one or more central modules.

Other details and particularities of the invention will emerge from the description of the schematic drawings which are attached to the present document and which illustrate, by way of non-limiting examples, the method and particular embodiments of the device according to the invention.

### BRIEF DESCRIPTION OF THE DRAWINGS

FIG. 1 shows a central module and a satellite comprising the equipment to which the invention relates and pairs of wires installed between the central module and the satellite.

FIGS. 2 and 3 show two methods of connection between the controlled converters and the satellite converters.

FIG. 4 shows an arrangement of a current measuring apparatus on one wire of a pair.

FIG. 5 shows a development of the measuring apparatus of FIG. 4, supplemented by a frequency-modulated signal transmitter and receiver.

FIG. 6 shows a type of connection of the transmitter of FIG. 5.

FIG. 7 shows a preferred type of connection of the transmitter shown in FIG. 5.

FIG. 8 shows a representation of the currents and voltages to be taken into account around a satellite converter for improved management of its functioning.

FIG. 9 shows in graph form the relationship between the input current of the satellite converter of FIG. 8 and the power which this can deliver.

FIG. 10 shows in graph form the relationship between a stabilisation voltage calculated for the satellite converter of FIG. 8 and the power which this can deliver.

FIG. 11 shows a normal earth connection of an item of telecommunication equipment and its supply source.

FIG. 12 shows, in addition to the connection depicted in FIG. 11, a connection of a device for monitoring earth connection or detecting an earth fault based on the voltage U, connected to the input poles of the telecommunication equipment.

FIG. 13 shows a connection with the details of output and input impedances to the pairs of wires, as well as the diode bridges.

### DETAILED DESCRIPTION OF THE INVENTION

In the various figures, the same reference notations designate identical or similar elements.

To facilitate understanding of the invention, without this being able to be considered to limit its scope, the device of the invention will be described first of all.

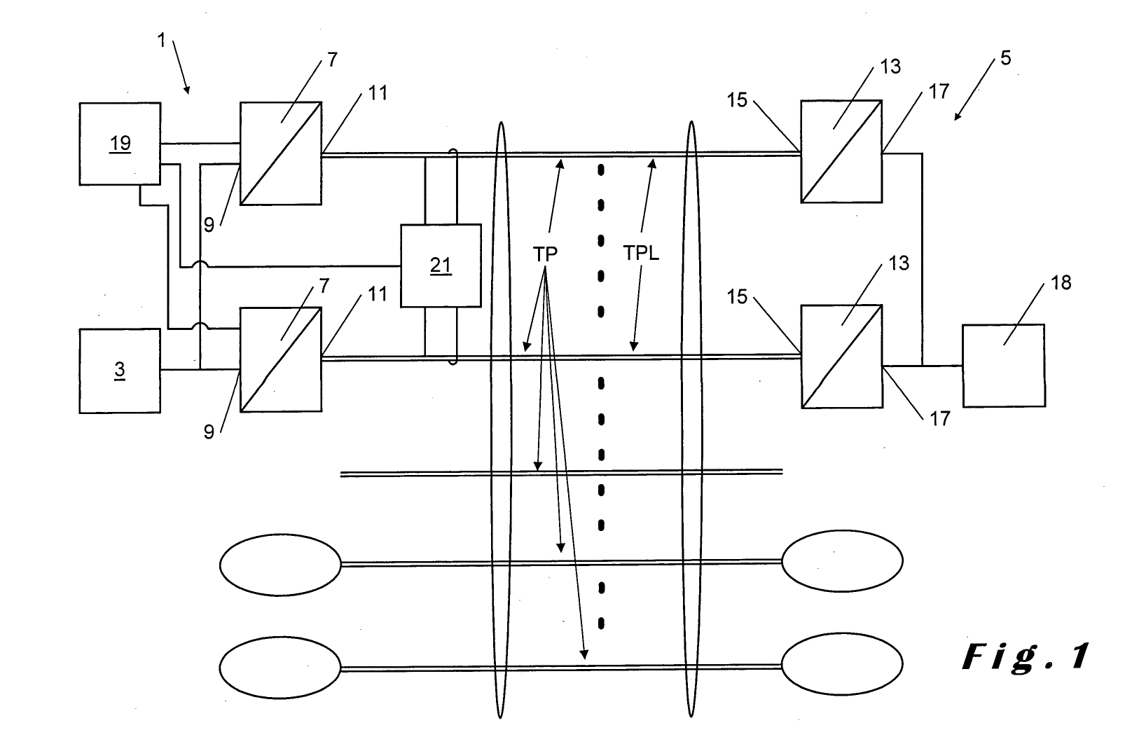

An electrical energy transmission device, of a given power, with which the invention is concerned, relates to a telecommunications system by wires which can comprise (FIG. 1)
a base station or central module 1,
a source 3 of electrical energy available to the central module 1, having a nominal voltage Ub of for example 48 volts dc (48 V dc hereinafter),
at least one auxiliary or satellite station 5 to be supplied with electrical energy, and
pairs of telecommunication wires TP (standing for “twisted pair” in English, that is to say “twisted pair of wires”) which connect the central module 1 and satellite 5.

Amongst these pairs of wires TP, many are in reserve and therefore not used for telecommunication. Some can then be used for the transmission of electrical energy. Providing for one pair of wires to be used both for energy transmission and for the transmission of data to the final user is however not excluded.

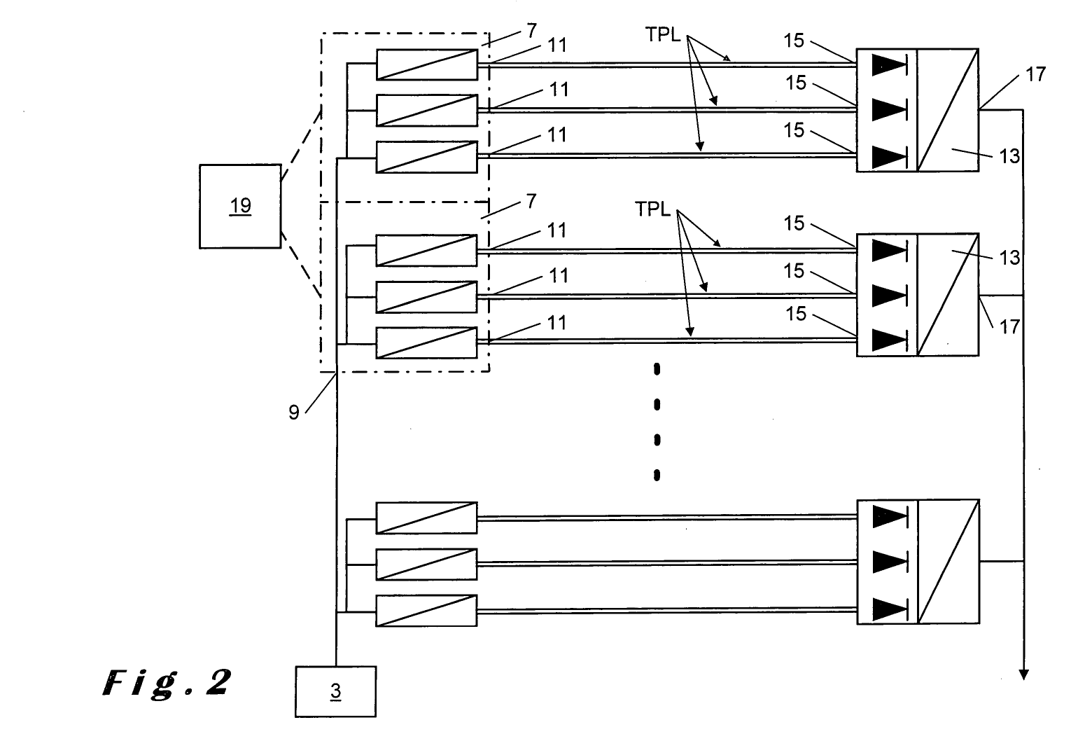

According to the invention, the device provided for this energy transmission comprises, at the central module 1, for each necessary and free pair of wires TPL used for the said transmission, a controlled converter 7 arranged so as to receive, at an input 9 connected to the energy source 3, the nominal voltage Ub and to transform this into chosen voltages, including an acceptable voltage Ua defined below, available at at least one output 11 connected to the said necessary free pair TPL. It must be understood here that one and the same control converter 7 can however serve to supply several pairs TPL (FIG. 2) and that, for this purpose, it may comprise several outputs 11, for example one output 11 per pair TPL, and even reserve outputs 11. In a controlled converter 7 used for the invention, the control provided is arranged so as to be able to adjust separately for each output 11 the voltage and current values and a cutting off of this voltage and current.

At the satellite 5, the necessary pair of wires TPL is connected to a satellite converter 13 which comprises an input 15, with a known input impedance Ze, and an output 17 connected in parallel with the output or outputs 17 of other satellite converters 13 in order to obtain the given power necessary for a use 18.

Control means 19, for example a microcontroller or a programmable automatic controller, are connected functionally to (or integrated in) each controlled converter 7; they are arranged so as to control this so that its or each above-mentioned output 11 delivers to the corresponding necessary wires TPL, at the time of starting up, a reduced safety voltage Us and current Is. Typically a control unit 19 is arranged to control six central converters 7.

For example, the controlled converter 7, provided for implementing the invention, may be an assembly of several units each comprising several independent converters 7 which may be controlled separately by the control means 19 of the programmable automatic controller type or the latter may control groups of three independent converters 7 or there may be a blending, according to particular requirements, of groups of different numbers of independent converters 7, where each group is controlled separately.

Connected functionally to the control means 19, there are means 21 of measuring the input impedance Ze of each satellite converter 13. These measuring means 21 are arranged so that, if the measured input impedance Zem does not correspond on each occasion to the known input impedance Ze of the satellite converter 13, they cause, by means of the control means 19, a cutting off of the supply to at least the pair or pairs TPL to which a non-correspondence relates, and a suspension of the starting up.

On the other hand, the measuring means 21 are arranged so that, if this measured input impedance Zem on each occasion corresponds to the known input impedance Ze, they cause, also by means of the control means 19, actuation of the corresponding control converter 7 so that the acceptable voltage Ua is delivered to its pair of wires TPL corresponding to the measurement, through the associated output 11, with the reduced safety current Is and, after a safety delay, with an acceptable intensity Ia defined below.

As proposed by FIG. 1, the measurement of the impedance Ze can be made through the pair of wires because the impedance of this pair is considered to be known.

As shown by FIG. 2, each necessary pair of wires TPL can be connected to a distinct output 11 of a controlled converter 7, and to a distinct input 15 of a satellite converter 13. Preferably, each output 11 of a controlled converter 7 is then arranged so as to give values of an order of magnitude complying with the safety standards, that is to say typically
2 milliamperes for an earth leakage current,
25 milliamperes maximum in the case of a differential leakage between two wires of reverse polarities in the same twisted pair or from one pair to another,
60 milliamperes for a maximum load intensity in RTF-C mode,
20 watts power maximum,
320 volts between the wires in the pair (i.e. ±160 volts between one wire and earth).

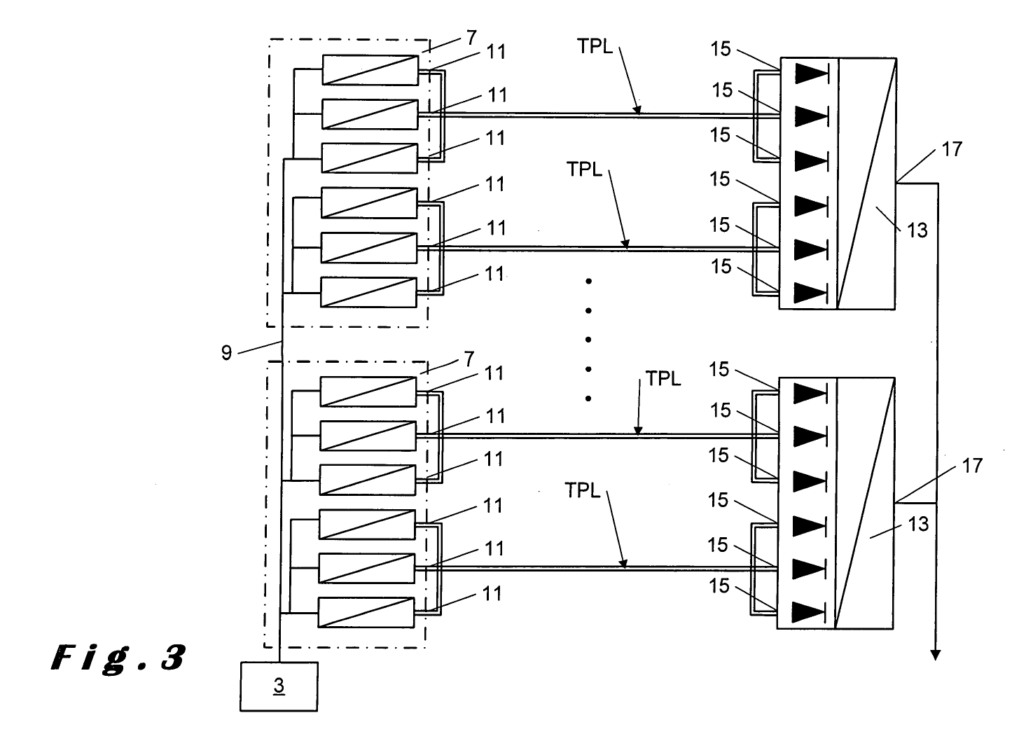

In another arrangement, shown in FIG. 3, each necessary pair of wires TPL is connected to three outputs 11 of a controlled converter or converters 7, advantageously of one and the same converter 7 which comprises three outputs, and with three to six inputs 15 of a satellite converter or converters 13, also advantageously of one and the same converter 13. Preferably here also, for each necessary pair of wires TPL, each of the said outputs 11 is arranged so as to give values of an order of magnitude complying with safety standards, that is to say typically
2 milliamperes for an earth leakage current,
20 milliamperes for a maximum load intensity in RTF-V mode,
60 watts maximum power,
320 volts between the wires and the pair (i.e. ±160 volts with respect to earth).

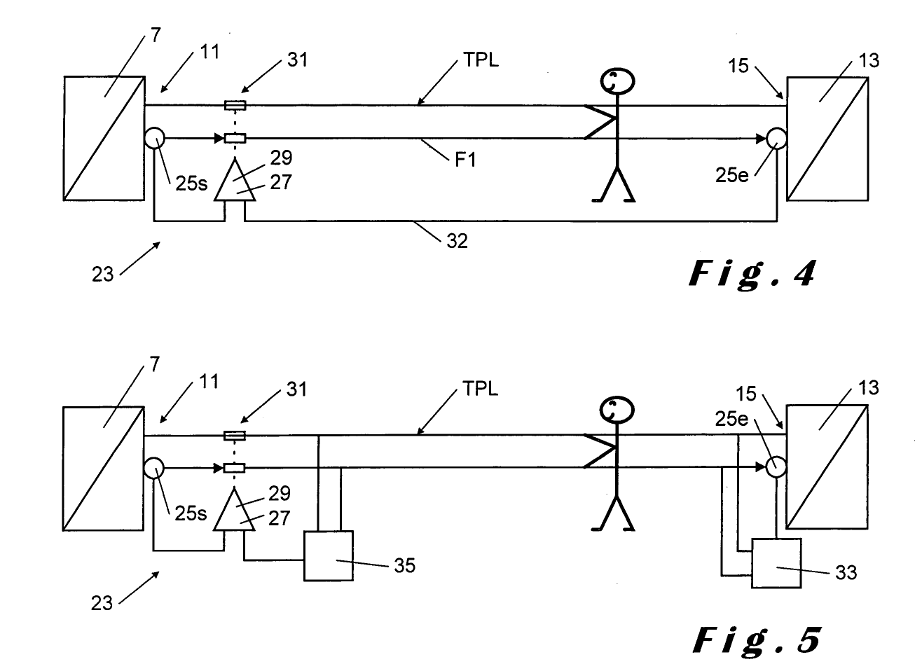

The device according to the invention can also comprise (FIG. 4) a measuring apparatus 23, different from the above measuring means 21, which comprises, functionally connected to each other, means 25 (25s, 25e) for simultaneously measuring, for each pair TPL, in one and the same wire F1 thereof, the current Ims at the output 11 of the controlled converter 7 and the current Ime at the input 15 of the satellite converter 13, and means 27 for calculating the difference between the current Ims at the output 11 and the current Ime at the input 15. To these calculation means 27 there are connected or functionally combined comparison means 29 for verifying whether this difference is less than or greater than a value typically of around 25 milliamperes (according to the standard IEC479-1 Table DC2), and these comparison means 29 are functionally connected to means 31 arranged so as to cut off the supply to at least this pair TPL if the difference is greater, with a cutoff reaction typically less than 20 milliseconds (according to the standard IEC479-1 Table DC2). For this purpose, these cutoff means can be connected to the controlled converter 7 or even form part of it.

The control means 19 of the controlled converter 7 being situated logically at the central module 1, the current measuring apparatus 23 is also installed there for preference, with the exception of the part 25e of the means 25 of measuring the current Ime at the input or inputs 15 of the satellite converter or converters 13.

In order to bring the current value Ime measured at the input or inputs 15 from the satellite 5 as far as the central module 1, a connection 32 which consumes at least one reserve wire would however be necessary.

To avoid this connection 32, the device of the invention can comprise (FIG. 5), associated with the part 25e of the measuring means 25, at the satellite 5, a transmitting appliance 33 arranged to transform this measured current value Ime into a modulated frequency according to the measured value and to apply this modulated frequency to the pair TPL of measured wires.

Then, at the controlled converter, a corresponding receiving appliance 35 is available, arranged to pick up the said modulated frequency on the same pair of wires TPL, to transform it inversely into the measured current value Ime and to transmit this value to the means 27 provided for calculating the said difference.

In a telecommunications system, the audio frequency band is between 300 and 3400 Hz and the one for a data transmission commences at 25 kHz. There will be chosen, for the modulated frequency transmitting the current Ime, an unused band situated between these two frequency bands, where cross-talk is not a nuisance, for example from 8000 Hz to 8200 Hz for a current ranging from 0 to 200 milliamperes respectively (that is to say an increase of 1 Hz per mA).

Superimposing the frequency of the measurement Ime on the pair TPL, rather than returning it to the central module 1 through another pair of monitoring wires, increases the safety level by redundancy of the information on the same pair and reduces overall the number of pairs allocated to the transportation of energy.

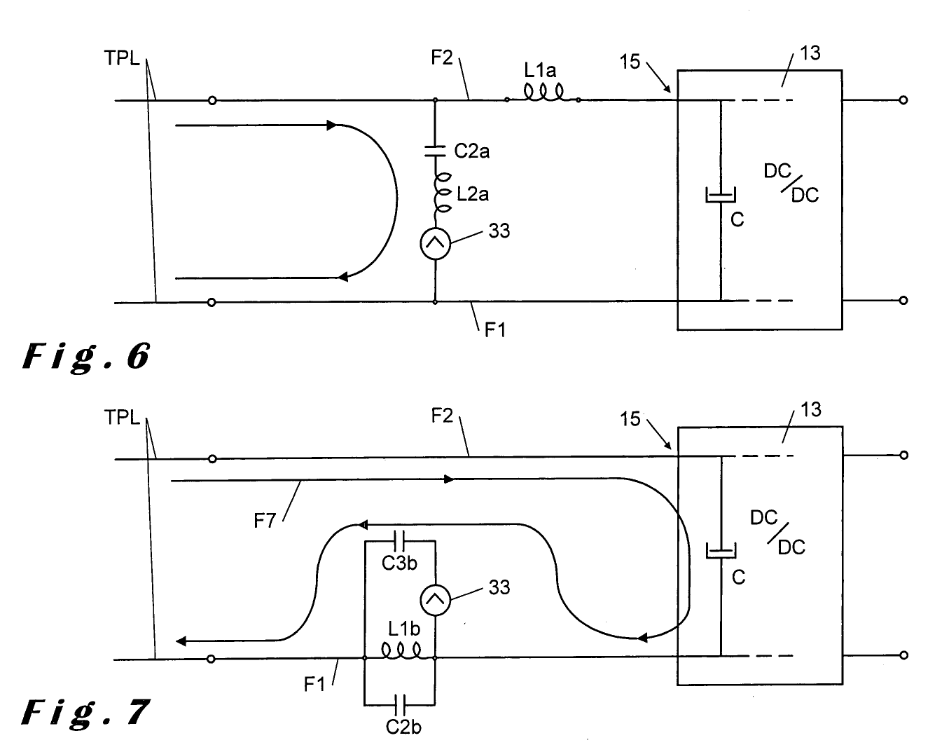

FIG. 6 shows a commonplace diagram for coupling the modulated frequency (FM) to the corresponding pair of wires TPL. From the transmitting appliance 33, one of the output terminals is connected directly to a wire F1 of the pair TPL whilst the other output terminal is connected to the other wire F2 of the pair by a serial connection of an FM coupling capacitor C2a (of 0.3 μF/400 V) and an FM coupling coil L2a (of 1 mH/200 mA). A decoupling coil L1a (of 1 mH/200 mA) must be placed between the terminal of the input 15 to this other wire F2 and the junction of the capacitor C2a and the said other wire F2. The input 15 usually comprises between its two terminals a decoupling capacitor C (of 10 μF). (The values indicated between parentheses are given by way of example.)

In the circuit in FIG. 6, an arrow F6 shows the path travelled by the signal FM produced by the transmitting appliance 33.

FIG. 7 shows a preferred diagram for the coupling of the modulated frequency (FM) to the corresponding pair of wires TPL. For example, between the wire F1 and the input terminal 15 of the satellite converter 13 intended for this wire F1 there is connected a triple parallel circuit of an FM decoupling capacitor C2b (of 3 μF/16 V), a decoupling coil L1b (of 100 pH/200 mA) and a group comprising in series the transmitting appliance 33 and a coupling capacitor C3b (of 2 μF/16 V).

In the circuit in FIG. 7, an arrow F7 shows the path travelled by the signal FM produced by the transmitting appliance 33. As can be seen, advantage is taken firstly of the presence of the decoupling appliance C (of 10 μF) and, advantageously on the other hand, the elements L1b and C3b are around ten times smaller than the respective elements L1a and C2a of the circuit of FIG. 6. In addition, the coil L2a in FIG. 6 is replaced in FIG. 7 by the smaller capacitor C3b.

A particular method of the invention is described below with reference to the above device, in order to facilitate understanding thereof, but without this being able to be taken as limiting the scope of the said method. Where applicable, the method gives programming steps and/or instructions for the programmable automatic controller mentioned above.

As disclosed at the start, the method of the invention is intended for a transmission of electrical energy in a secure manner, with a given power, in a system for cabled telecommunication as described above.

At the start, according to FIG. 1, a selection of pairs of free wires TPL between the central module 1 and the satellite 5 is made, and a selection of the voltage Ua and current Ia allowed in each pair of free wires TPL. From a calculation of a useful power which each pair of free wires TPL can transmit, the number of pairs TPL necessary for transmitting the given power is calculated, dividing this by the said useful power per pair.

Next it is possible to effect a switching, to the said source of energy 3 of the central module 1, of each pair TPL necessary by means of at least one output 11 of a controlled converter 7, which converts the nominal voltage into chosen voltages, including the accepted voltage Ua.

At the satellite, each necessary pair TPL is switched to at least one input 15 of a satellite converter 13, with a known input impedance and which, receiving at the input 15 the accepted voltage Ua, makes a useful voltage for the satellite 5 available at an output 17. In addition outputs 17 of the satellite converters 13 are switched in parallel in order to obtain the given power.

According to the invention, so that the operations are carried out under the best safety conditions, the method comprises, when an energy transmission is started up, a command to the or each controlled converter 7 so that its output 11 delivers to its corresponding pair of wires TPL a continuous reduced safety voltage Us and current Is.

The continuous voltage Us of a few volts (<10 V) applied by the central converter can comprise the information from the group of pairs to which it is connected to the central converter 7. One practical embodiment consists of adding an alternative component (AC) of low amplitude of around 1 volt, whose frequency (a few tens of hertz) is a function of the group (varying here from 1 to 14) of pairs and the address (varying here from 1 to 20) of the central converter 7, which makes it possible, with a frequency meter at the end of the line, easily to locate the twisted pairs to be connected to the inputs of the same satellite converter 13. Whilst receiving the information from the group of pairs, the load or input impedance Ze is measured and, as long as it does not correspond to the input impedance Zem of a satellite converter 13, the system remains in this state of starting.

If the measured input impedance Zem corresponds on each occasion to the known input impedance Ze, a command for the or each controlled converter 7 is organised so that each delivers the accepted voltage Ua to its pair of wires, with the reduced safety current Is.

After a safety delay, a continuation of the start-up is organised by a command to the or each controlled converter 7 so that each delivers to its pair of wires TPL the accepted voltage Ua and current.

Advantageously, for the said measurement of the input impedance Ze, the controlled converter 7 is adjusted so that each necessary pair of wires TPL receives a very low safety voltage Us, without any physiological effect for humans, typically around 50 volts and, preferably, a very low safety current Is, without any danger for humans, typically around 10 milliamperes. Lower values may be envisaged but they must be of sufficient level to obtain a reliable measurement of the impedance.

If the measured input impedance Zem corresponds to the known input impedance Ze, it is possible then to adjust the controlled converter 7 so that, during the safety delay, each necessary pair of wires TPL receives the accepted voltage Ua in particular between ±110 and ±230 volts, typically around 160 volts, and a safety current Is typically around 5 milliamperes.

Whilst testing the impedance, each central converter 7 produces a signal whose frequency is a function of the group number, varying here from 1 to 14, and of the address of the module (varying here from 1 to 16) of which it forms part. For example, the frequency 101.24 Hz signifies the group of pairs 10 and the central address module 12; the last FIG. 4, not having any meaning, must be ignored.

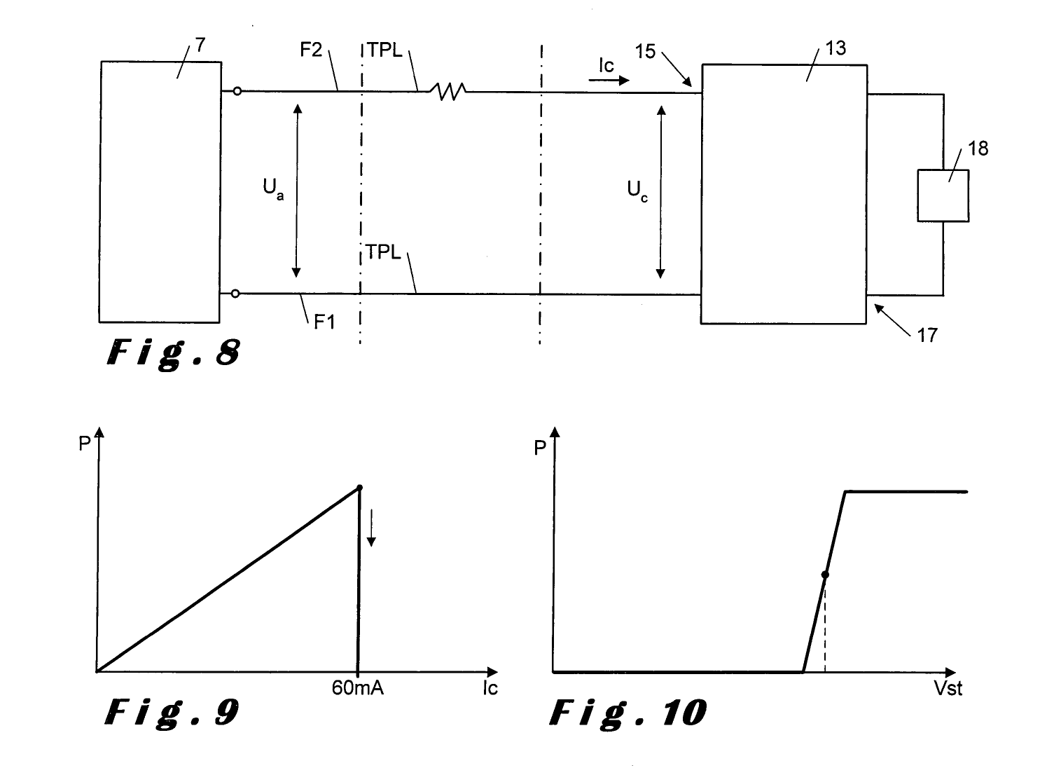

The satellite converter 13, from DC to DC, functioning by chopping, always has a negative input resistance, and therefore if (FIG. 8) the input voltage Uc decreases, the current at the input Ic increases. The accepted voltage Ua applied to the pair TPL is limited in current Ia to for example 60 milliamperes. If the graph in FIG. 9 is considered, which shows the curve of the available power P as a function of the current Ia in the pair TPL, it is known that this curve stops at an optimum point corresponding to a current of 60 mA and that this point is unstable, a fortuitous additional power demand leads to the collapse of the available power. To avoid this, it is necessary to constantly keep the current below 60 mA, and this is not easy in this context.

To mitigate this problem, it is proposed to provide the satellite converter with an “intelligent” calculator and to program this so as to
calculate the line resistance RL of the pair TPL at a given moment whilst it knows the values Ua, Ic and Uc defined above, RL=(Ua−Uc)/Ic,
calculate a stabilisation voltage Ust=Us−(60 mA×RL).

The graph in FIG. 10 shows the curve of the power P as a function of the stabilisation voltage Ust, to be taken into consideration in this case. It is clear that, since the operating point for the value Ust is situated on a slope away from the ends of this slope, an error on the value of this stabilisation voltage Ust has no nuisance effect on the power passed and in particular on the general functioning of the apparatus connected to the satellite converter 13.

Referring to FIG. 13, the output voltage of the central converters are symmetrical with respect to earth (for example +160 and −160 V), providing for high impedances 51 to 56 of equal values (for example 1 megohm). For the safety of the operators responsible for wiring the device of the invention, it is therefore necessary to ensure that the connections to earth are correct.

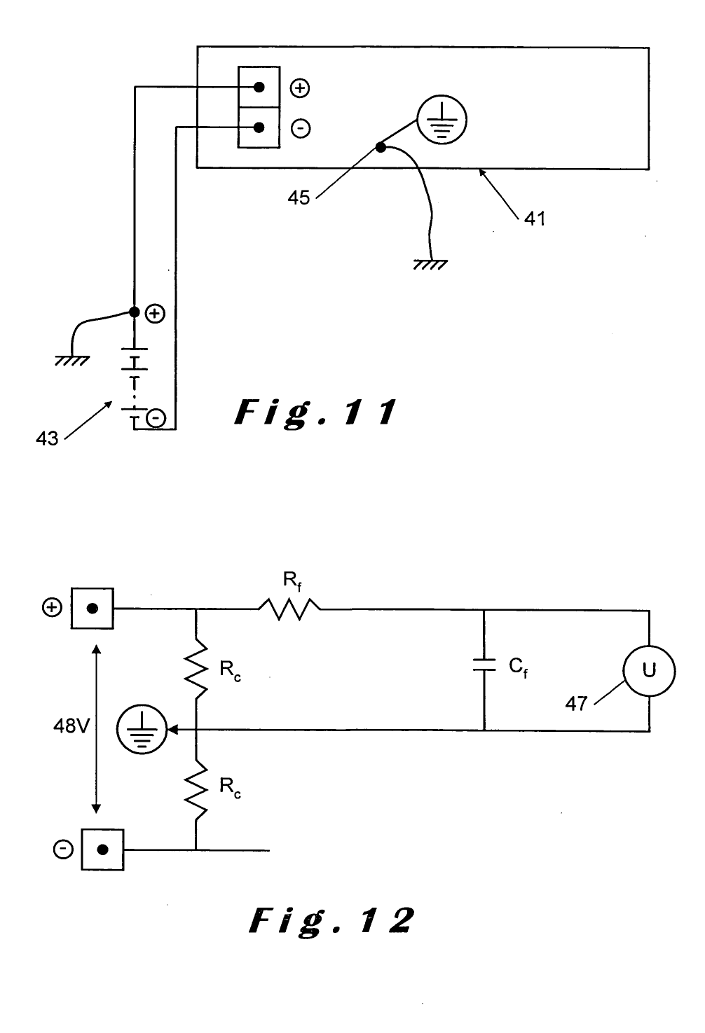

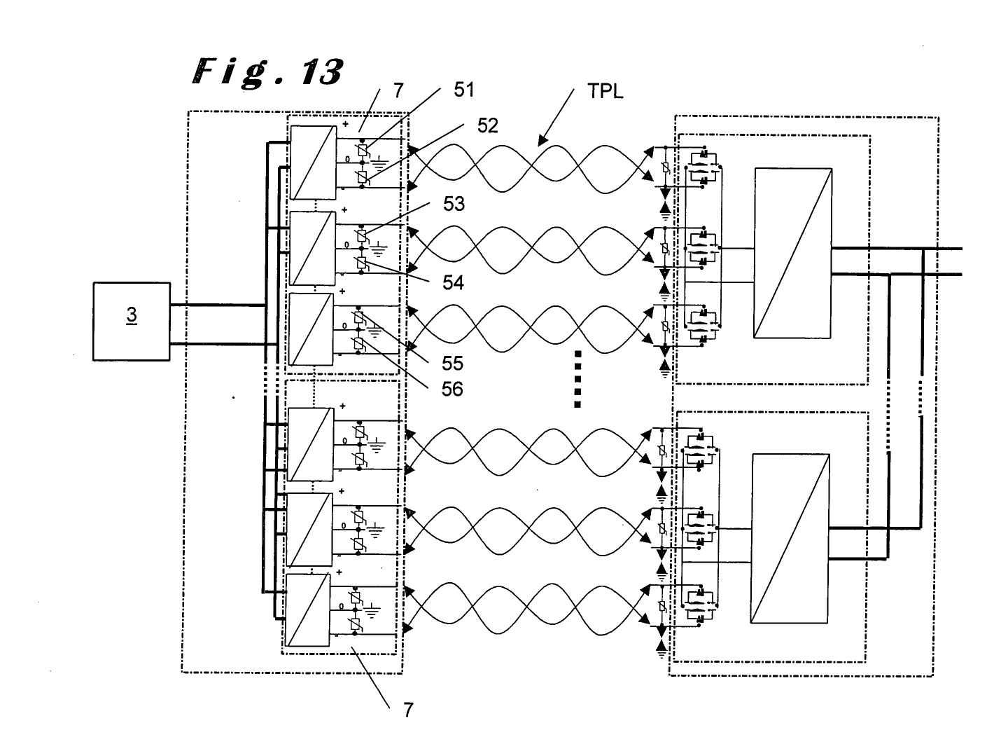

To this end, FIGS. 11 and 12 show an appropriate method of connection. Equipment 41, such as telecommunication equipment, is frequently supplied by an accumulator 43, where it is known how to connect the positive pole to earth where this battery 43 is situated. Because of this, the positive pole of the equipment 41 is also connected to earth. The positive and negative supply input poles of this equipment 41 are galvanically isolated from this chassis 45. It is then proposed
firstly to connect the metallic chassis 45 of the equipment 41 to earth at the point where it is situated,
secondly to separately connect the positive and negative poles of the equipment 41 to the chassis 45 thereof by in each case a drop resistance R+ and R−. These resistances are typically of around 10 kilohms in order to limit losses.

This circuit is completed by a voltage measuring means 47 connected between the positive pole of the equipment 41 and the chassis 45 thereof, by means of a filtering circuit advantageously comprising a resistor Rf and a capacitor Cf. A measured voltage output of this measuring means 45 is connected to a comparison means, known per se, for comparing the said measured voltage with a voltage threshold of typically 3 volts and to supply a warning signal or, preferably, a usable signal for immediately cutting off the supply to the equipment 41 in question.

For example, if the battery 43 delivers 48 volts to the equipment 41, and if the earth tappings are well-connected on each side and effective, the measuring means 47 cannot detect more than 3 or 4 volts. Higher values signify a deficiency of one or other earth tapping. A value of around 25 volts signifies an absence of at least one connection to earth. It will be understood that, by establishing a single earth tapping for the equipment 41, there is at the same time obtained a control of the earth tapping of the battery 43 and a control of that of the said equipment 41. This device is also a means of controlling the voltage drop in the supply cable and therefore a verification of the matching of the cross-section of the cable with respect to the intensity of the current flowing therein.

In other words the device comprises, when the energy source is a DC voltage source, means arranged to determine the impedance between the chassis of the central converters and one of the said terminals of the energy source, in particular the positive terminal, and to generate a signal when the impedance exceeds a predetermined threshold. This signal can be used to generate an alarm or where necessary to cut off the supply to the relevant pairs of wires of the chassis in question. The means illustrated in FIG. 12 determine the impedance by measuring the voltage between the positive terminal and the chassis of the central equipment. It is verified that this voltage does not exceed a certain threshold, for example 4 volts.

### Legend to the Figures

Cf filtering capacitor (FIG. 12)

F1 one wire in a pair TP/TPL

F2 the other wire in a pair TP/TPL

F6 arrow for the path of the FM signal FIG. 6

F7 arrow of the path of the FM signal FIG. 7

Ia accepted current

Ic input current of 13 (FIG. 8)

Ime current measured at 15

Ims current measured at 11

Is safety current

Rc drop resistance (FIG. 12)

Rf filtering resistance (FIG. 12)

RI line resistance (FIG. 1)

TP pair of wires

TPL free pair of wires

Ust stabilisation voltage

Ua accepted voltage

Ub nominal voltage

Uc input voltage of 13 (FIG. 8)

Us safety voltage

Ze input impedance of 13

Zem measured input impedance of 13

1 base or central station

3 source of energy or current at 1

5 auxiliary or satellite station

7 controlled converter at 1

9 input of 7

11 output of 7

13 satellite converter at 5

15 input of 13

17 output of 13

19 control means of 7

21 impedance measurement means

23 current measuring apparatus

25 means of measuring intensity on wire F1 or F2 of 23 (in particular 25e and 25s)

27 means of calculating difference in current of 23

29 comparison means of 23

31 means of cutting off supply

33 transmitting appliance

35 receiving appliance

41 electronic equipment

43 accumulator

45 metallic chassis

47 voltage measuring means

51 to 56 output impedance of central converters in a group

1. Energy transmission device in a system for cabled telecommunication, the system comprising first and second pairs of telecommunication wires (TP), the device comprising:
a central module (1) or base station arranged to be connected to a source of electrical energy and for the first and second pairs of wires to be connected thereto;
a satellite (5) or auxiliary station, the satellite comprising a first satellite converter (13), the first satellite converter comprising:
a first input arranged for the first pair of wires to be connected thereto, and
a second input arranged for the second pair of wires to be connected thereto.

2. Device according to claim 1, wherein the system also comprises third and fourth pairs of telecommunication wires (TP), in which:
the satellite comprises a second satellite converter arranged for the third and fourth pairs of wires to be connected thereto;
the central module (1) is arranged for:
the third and fourth pairs of wires to be connected thereto;
a first signal to be produced and for this first signal to be transmitted to the first and second pairs of wires;
a second signal different from the first signal to be produced and for this second signal to be transmitted to the third and fourth pairs of wires.

3. Device according to claim 1, in which the satellite converter comprises:
a first diode bridge comprising a first non-biased input connected to the first input of the satellite converter and a first biased output;
a second diode bridge comprising a second non-biased input connected to the second input of the satellite converter and a second biased output; and
in which the first biased output is connected to the second biased output, the said biased output being arranged to supply energy to the input stage of the satellite converter.

4. Device according to claim 1, comprising impedance measuring means (21) arranged to measure the input impedance of the satellite converter; and control means connected to the measuring means and arranged to cause a cutting off of the supply to the pairs of wires concerned if a measured input impedance (Zem) has a value different from a range of predetermined values.

5. Device according to claim 1, comprising control means (19) arranged to control the current limitation level for each pair of wires.

6. Device according to claim 1, in which the satellite converters are arranged so as to generate an identification signal and transmit it to the central module and in which the central module is arranged to receive the identification signal.

7. Device according to claim 6, in which the identification signal is the measurement of the input current of the satellite converter and the central module comprises means arranged to cause a cutting off of the supply to the pair of wires concerned when the difference between the input current of the satellite converter and a corresponding output current of the central module reaches a predetermined threshold.

8. Device according to claim 6, comprising means arranged to transform an input current (Ime) at an input (15) of the satellite converter (13) into a frequency varying according to the measured value, applying, close to the input (15) of the corresponding satellite converter (13), this frequency to the measured pair of wires (TPL), sampling this frequency close to an output of the corresponding controlled converter, and using this frequency for comparing it with a local measurement of the satellite converter (13).

9. Device according to claim 1, in which the central module is arranged to generate a cutting off of current in one of the pairs of wires whilst maintaining the supply in the other pairs of wires.

10. Device according to claim 1, in which the central module (1) comprises central converters, each central converter being connected respectively to one of the pairs of wires.

11. Device according to claim 1, comprising means connected to the satellite converter arranged to determine a stabilisation voltage Ust (Ust=Ua−(Imax×RL)) to be applied to the satellite converter, in which
Ua is the output voltage of the central converter,
Imax is the maximum current allowed,
RL is the line resistance of the pair of wires, determined by RL=(Ua−Uc)/Ic, Uc being the input voltage of the satellite converter, Ic being the line current at a given moment.

12. Device according to claim 10, in which the central converters comprise a chassis, the device comprising, when the energy source is a DC voltage source comprising a positive and negative terminal, means connected to the central module arranged so as:
to determine an impedance between the chassis of the central converters and one of the said terminals of the energy source, in particular the positive terminal, and
to generate a signal when the impedance exceeds a predetermined threshold.
